(19) United States
(12) Patent Application Publication
(10) Pub. No.: US 2025/0272584 A1
(43) Pub. Date: Aug. 28, 2025

(54) INFORMATION PROCESSING APPARATUS, INFORMATION PROCESSING SYSTEM, INFORMATION PROCESSING METHOD, AND RECORDING MEDIUM

(71) Applicant: NEC Corporation, Tokyo (JP)

(72) Inventors: Kosuke KIHARA, Tokyo (JP); Junki Mori, Tokyo (JP); Isamu Teranishi, Tokyo (JP)

(73) Assignee: NEC Corporation, Tokyo (JP)

(21) Appl. No.: 19/052,451

(22) Filed: Feb. 13, 2025

(30) Foreign Application Priority Data
Feb. 22, 2024 (JP) 2024-025962

(51) Int. Cl. G06N 5/04

(52) U.S. Cl. CPC G06N 5/04

(57) ABSTRACT

An information processing apparatus includes: a target data acquiring section that acquires target data; a reliability level calculating section that, from at least one of a plurality of models and the target data, calculates a reliability level of the at least one of the plurality of models on the basis of an agreement degree between labels obtained by at least one of a plurality of label generating means; and a label determining section that refers to the reliability level to determine a label to be assigned to the target data.

This Nonprovisional application claims priority under 35 U.S.C. § 119 on Patent Application No. 2024-025962 filed in Japan on Feb. 22, 2024, the entire contents of which are hereby incorporated by reference.

### TECHNICAL FIELD

The present disclosure relates to an information processing apparatus, an information processing system, an information processing method, and a recording medium.

### BACKGROUND ART

In supervised machine learning, training data to which a ground-truth label is assigned is ordinarily used. However, it is difficult in some cases to assign such a ground-truth label in advance. A technique is known in which, in such a case, a pseudo label is generated and pseudo label-assigned data is used as training data (for example, Patent Literature 1).

### CITATION LIST

### Patent Literature

### [Patent Literature 1]

Japanese Patent Application Publication Tokukai No. 2023-13293

### SUMMARY OF INVENTION

### Technical Problem

In a technique using a pseudo label, the pseudo label that is as highly reliable as possible is preferably generated. However, even in a case where the technique disclosed in Patent Literature 1 is used, there is a problem in terms of reliability of the pseudo label. The present disclosure has been made in view of the above problem, and an example object thereof is to provide a technique that makes it possible to generate a highly reliable pseudo label (label).

### Solution to Problem

An information processing apparatus in accordance with an example aspect of the present disclosure includes at least one processor, the at least one processor carrying out: a target data acquiring process for acquiring target data; a reliability level calculating process for, from at least one of a plurality of models and the target data, calculating a reliability level of the at least one of the plurality of models on the basis of an agreement degree between labels obtained by at least one of a plurality of label generating means; and a label determining process for referring to the reliability level to determine a label to be assigned to the target data.

An information processing system in accordance with an example aspect of the present disclosure is an information processing system including a server apparatus and a plurality of client apparatuses, the server apparatus including at least one first processor, the at least one first processor carrying out an acquisition process for acquiring models from the respective plurality of client apparatuses, an aggregation process for aggregating the models acquired from the respective plurality of client apparatuses, and a provision process for providing each of the plurality of client apparatuses with a model group including the models aggregated by the aggregation process, the plurality of client apparatus each including at least one second processor, the at least one second processor carrying out a model acquiring process for acquiring a plurality of models included in the model group provided by the server apparatus, a target data acquiring process for acquiring target data, a reliability level calculating process for, from at least one of the plurality of models and the target data, calculating a reliability level of the at least one of the plurality of models on the basis of an agreement degree between labels obtained by at least one of a plurality of label generating means, a label determining process for referring to the reliability level to determine a label to be assigned to the target data, and a training process with reference to the label determined by the label determining process.

An information processing method in accordance with an example aspect of the present disclosure includes: acquiring target data; from at least one of a plurality of models and the target data, calculating a reliability level of the at least one of the plurality of models on the basis of an agreement degree between labels obtained by at least one of a plurality of label generating means; and referring to the reliability level to determine a label to be assigned to the target data.

A non-transitory recording medium in accordance with an example aspect of the present disclosure is a non-transitory recording medium storing therein a program for causing a computer to function as an information processing apparatus, the program causing the computer to carry out: a target data acquiring process for acquiring target data; a reliability level calculating process for, from at least one of a plurality of models and the target data, calculating a reliability level of the at least one of the plurality of models on the basis of an agreement degree between labels obtained by at least one of a plurality of label generating means; and a label determining process for referring to the reliability level to determine a label to be assigned to the target data.

Note that the information processing apparatus in accordance with each aspect may be realized by a computer. In this case, the present invention also encompasses, in its scope, (i) a program for causing a computer to operate as each means included in the information processing apparatus so that the information processing apparatus is realized by the computer and (ii) a computer-readable recording medium in which the program is recorded.

### Advantageous Effects of Invention

An example aspect of the present disclosure brings about an example effect of making it possible to generate a highly reliable pseudo label (label).

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing system in accordance with the present disclosure.

FIG. 4 is a flowchart illustrating a flow of an information processing method in accordance with the present disclosure.

FIG. 5 is a block diagram illustrating a configuration of an information processing apparatus in accordance with the present disclosure.

FIG. 6 is a diagram for describing a process carried out by the information processing apparatus in accordance with the present disclosure.

FIG. 7 is a diagram for describing a process carried out by the information processing apparatus in accordance with the present disclosure.

FIG. 8 is a diagram for describing a process carried out by the information processing apparatus in accordance with the present disclosure.

FIG. 9 is a diagram for describing a process carried out by the information processing apparatus in accordance with the present disclosure.

FIG. 10 is a block diagram illustrating a configuration of an information processing system in accordance with the present disclosure.

FIG. 11 is a diagram for describing a process carried out by the information processing system in accordance with the present disclosure.

FIG. 12 is a diagram for describing a process carried out by the information processing system in accordance with the present disclosure.

FIG. 13 is a block diagram illustrating a configuration of a computer which functions as an information processing apparatus in accordance with the present disclosure.

### EXAMPLE EMBODIMENTS

The following description will discuss example embodiments of the present invention. Note, however, that the present invention is not limited to the example embodiments described below, but can be altered in various ways by a skilled person in the art within the scope of the claims. For example, the present invention can also encompass, in its scope, any example embodiment derived by appropriately combining technical means employed in the example embodiments described below. Further, the present invention can also encompass, in its scope, any example embodiment derived by appropriately omitting a part of a technical means employed in each of the example embodiments described below. Furthermore, the effects mentioned in the example embodiments described below are example effects expected in the example embodiments described below, and are not intended to define an extension of the present invention. That is, the present invention can also encompass, in its scope, any example embodiment that does not bring about any of the effects mentioned in the example embodiments described below.

### First Example Embodiment

The following description will discuss a first example embodiment, which is an example embodiment of the present invention, in detail with reference to the drawings. The present example embodiment is a basic form of the example embodiments described later. Note that the scope of application of technical means which are employed in the present example embodiment is not limited to the present example embodiment. That is, the technical means which are employed in the present example embodiment can be employed also in the other example embodiments included in the present disclosure, provided that no particular technical problem occurs. Moreover, technical means which are indicated in the drawings referred to for describing the present example embodiment can be employed also in the other example embodiments included in the present disclosure, provided that no particular technical problem occurs.

(Configuration of Information Processing apparatus 1)

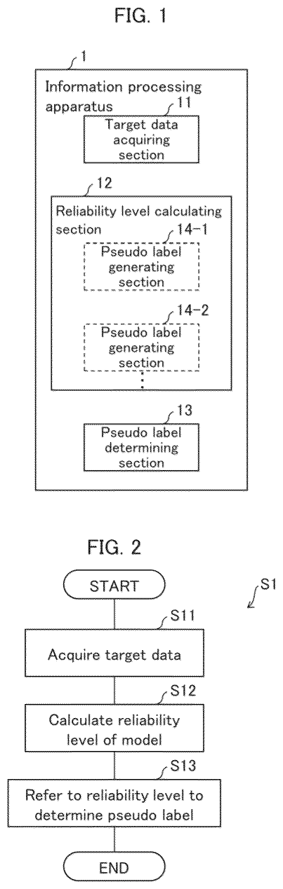

A configuration of an information processing apparatus 1 in accordance with the present example embodiment is described below with reference to FIG. 1. FIG. 1 is a block diagram illustrating the configuration of the information processing apparatus 1 in accordance with the present example embodiment. The information processing apparatus 1 includes a target data acquiring section 11, a reliability level calculating section 12, and a pseudo label determining section (label determining section) 13 as illustrated in FIG. 1.

In the following description, the wording “pseudo label” is used. Note, however, that the wording “pseudo” is not intended to limit the present example embodiment. A configuration obtained by reading the wording “pseudo label” as “label” is also encompassed in the present example embodiment.

### (Target Data Acquiring Section 11)

The target data acquiring section 11 acquires data (target data) to be processed. Note here that examples of the target data include data without a ground-truth label (also called a training label). Further, although a type of data included in the target data is not particularly limited, the data can be, for example, any of image data, text data, and sensor ring data.

### (Reliability Level Calculating Section 12)

By inputting at least one of a plurality of models and the target data into at least one of a plurality of pseudo label generating means, the reliability level calculating section 12 calculates a reliability level of the at least one of the plurality of models. For example, from at least one of a plurality of models and the target data, the reliability level calculating section 12 calculates a reliability level of the at least one of the plurality of models on the basis of an agreement degree between labels obtained by at least one of a plurality of pseudo label generating means (a plurality of label generating means).

Note here that the plurality of models can include, for example, a model which uses the target data as input to output an inference result (estimation result, prediction result) for the target data. However, this is not intended to limit the present example embodiment. Note also that the wording “model” can include the meaning of “at least one parameter defining a model”. Further, although a specific configuration of the model is not particularly limited in the present example embodiment, the model can be, for example, any of a convolutional neural network (CNN), a recurrent neural network (RNN), and a combination of these.

The pseudo label generating means is a means for using target data and a model as input and using at least part of the model to generate a pseudo label for the target data. The pseudo label generating means is configured, for example, as a program for executing a pseudo label generation algorithm, and the algorithm can include information pertaining to, for example, the following:
output from which of a plurality of layers included in the above model to refer to; and
by what process to carry out with respect to the output from a corresponding one of the plurality of layers to generate a pseudo label.

Note that the reliability level calculating section 12 may or need not be configured to include the plurality of pseudo label generating means. For example, as illustrated in FIG. 1, the reliability level calculating section 12 may or need not be configured to include pseudo label generating sections 14-1, 14-2, . . . as the respective plurality of pseudo label generating means.

In other words, for example, the reliability level calculating section 12 may be configured as a reliability level calculation program for executing a reliability level calculation algorithm, and may be configured to include, in the reliability level calculation program, pseudo label generation programs corresponding to the respective plurality of pseudo label generating means. Note here that, for example, the pseudo label generation programs are executed by the foregoing respective pseudo label generating sections 14-1, 14-2, . . . Alternatively, the reliability level calculating section 12 may be configured as a reliability level calculation program for executing a reliability level calculation algorithm, and may be configured to invoke, from the reliability level calculation program, pseudo label generation programs corresponding to the respective plurality of pseudo label generating means, and use the pseudo label generation programs.

Further, for example, the reliability level calculating section 12 may be configured to assign, to a first model among the plurality of models, a reliability level in accordance with a degree of agreement (agreement degree) between
a first pseudo label obtained by inputting the first model and the target data into a first pseudo label generating means among the plurality of pseudo label generating means and
a second pseudo label obtained by inputting the first model and the target data into a second pseudo label generating means among the plurality of pseudo label generating means. Alternatively, the reliability level calculating section 12 may be configured to refer to: a first degree of agreement (first agreement degree), which is a degree of agreement between
a first pseudo label obtained by inputting a first model among the plurality of models and the target data into a first pseudo label generating means among the plurality of pseudo label generating means and
a second pseudo label obtained by inputting the first model and the target data into a second pseudo label generating means among the plurality of pseudo label generating means; and
   a second degree of agreement (second agreement degree), which is a degree of agreement between
a third pseudo label obtained by inputting a second model among the plurality of models and the target data into the first pseudo label generating means and
a fourth pseudo label obtained by inputting the second model and the target data into the second pseudo label generating means, and
   assign a higher reliability level to the first model than to the second model in a case where the first degree of agreement is higher than the second degree of agreement. Note, however, that the above example is not intended to limit the present example embodiment.

### (Pseudo Label Determining Section 13)

The pseudo label determining section 13 refers to the reliability level, which has been calculated by the reliability level calculating section 12, to determine a pseudo label to be assigned to the target data. For example, the pseudo label determining section 13 determines, as the pseudo label to be assigned to the target data, a pseudo label generated with use of at least one model that is among the foregoing plurality of models and that has a higher reliability level. Note here that “a higher reliability level” may be, for example, “a reliability level higher than a predetermined threshold” or may be “a relatively high reliability level among respective reliability levels of the plurality of models”.

For example, in a case where a predetermined threshold is 80%, and the reliability level calculating section 12 calculates, for a model A, a reliability level of 90%, which is higher than the predetermined threshold, the pseudo label determining section 13 may determine, as the pseudo label to be assigned to the target data, a pseudo label generated with use of the model A.

Alternatively, in a case where the reliability level calculating section 12 calculates reliability levels of 70%, 80%, and 30% for the model A, a model B, and a model C, respectively, the pseudo label determining section 13 may determine, as the pseudo label to be assigned to the target data, a pseudo label generated with use of the models A and B that have relatively high reliability levels.

Further, the pseudo label determining section 13 may
generate a pseudo label by inputting, into at least one of the foregoing plurality of label generating means, the foregoing target data and each of at least one model that is among the foregoing plurality of models and that has a higher reliability level, and
determine the generated pseudo label as the pseudo label to be assigned to the target data.

In other words, the pseudo label determining section 13
may be configured to select, as the pseudo label to be assigned to the target data, a pseudo label generated by inputting, into the at least one of the plurality of pseudo label generating means, the target data and a model that has a higher reliability level among reliability levels calculated by the reliability level calculating means for the respective plurality of models, or
may be configured to, by inputting, into the at least one of the pseudo label generating means, the target data and each of models each of which has a higher reliability level among reliability levels calculated by the reliability level calculating means for the respective plurality of models, generate the pseudo label to be assigned to the target data. Note, however, that these specific examples are not intended to limit the present example embodiment.

### (Effect of Information Processing Apparatus 1)

As described above, a configuration is employed such that the information processing apparatus 1 in accordance with the present example embodiment acquires target data,
by inputting at least one of a plurality of models and the target data into at least one of a plurality of pseudo label generating means, calculates a reliability level of the at least one of the plurality of models, and
refers to the reliability level to determine a pseudo label to be assigned to the target data. Thus, the above configuration makes it possible to generate a highly reliable pseudo label (label).

### (Flow of Information Processing Method S1)

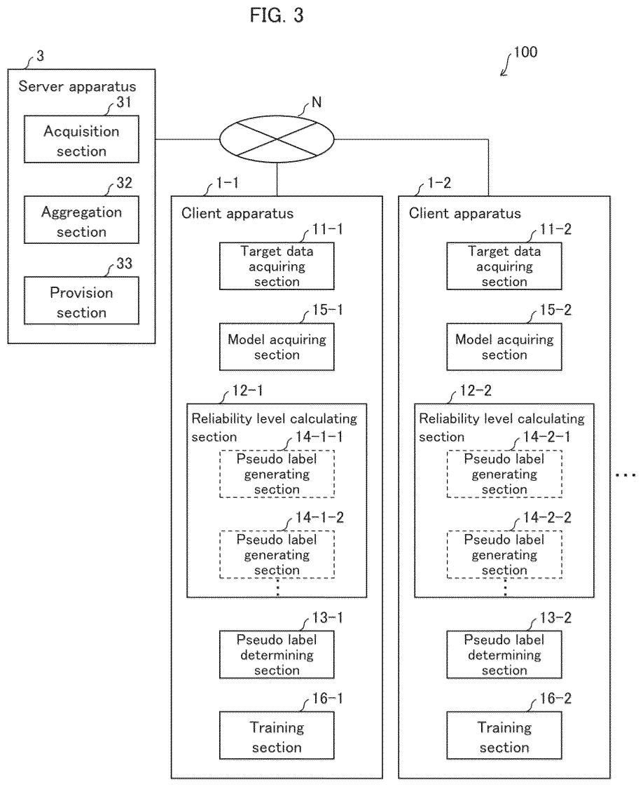

Next, a flow of an information processing method S1 in accordance with the present example embodiment will be described with reference to FIG. 2. FIG. 2 is a flowchart illustrating the flow of the information processing method S1. The information processing method S1 includes, as illustrated in FIG. 2, a process (step) S11 for acquiring target data, a process (step) S12 for calculating a reliability level of a model, and a process (step) S13 for referring to the reliability level to determine a pseudo label.

### (Step S11)

In step S11, the target data acquiring section 11 acquires data (target data) to be processed. Since a specific process carried out by the target data acquiring section 11 has been described earlier, a description thereof is omitted here.

### (Step S12)

Next, in step S12, by inputting, into at least one of a plurality of pseudo label generating means, at least one of a plurality of models and the target data acquired in step S11, the reliability level calculating section 12 calculates a reliability level of the at least one of the plurality of models. In other words, in step S12, by referring to at least one of a plurality of models and the target data in at least one of a plurality of pseudo label generating processes, the reliability level calculating section 12 calculates a reliability level of the at least one of the plurality of models. For example, from at least one of a plurality of models and the target data, the reliability level calculating section 12 calculates a reliability level of the at least one of the plurality of models on the basis of an agreement degree between labels obtained by at least one of a plurality of pseudo label generating means (a plurality of label generating means). Since a specific process carried out by the reliability level calculating section 12 has been described earlier, a description thereof is omitted here.

### (Step S13)

Subsequently, in step S13, the pseudo label determining section 13 refers to the reliability level, which has been calculated by the reliability level calculating section 12 in step S12, to determine a pseudo label to be assigned to the target data. Since a specific process carried out by the pseudo label determining section 13 has been described earlier, a description thereof is omitted here.

### (Effect of Information Processing Method S1)

As described above, in the information processing method S1 in accordance with the present example embodiment, a process for
acquiring target data,
by inputting at least one of a plurality of models and the target data into at least one of a plurality of pseudo label generating means, calculating a reliability level of the at least one of the plurality of models, and
   referring to the reliability level to determine a pseudo label to be assigned to the target data is carried out. The information processing method S1 including the above process brings about an effect similar to that brought about by the information processing apparatus 1 in accordance with the present example embodiment.

### (Configuration of Information Processing System)

Next, a configuration of an information processing system in accordance with the present example embodiment will be described with reference to FIG. 3. FIG. 3 is a block diagram illustrating a configuration of an information processing system 100 in accordance with the present example embodiment. The information processing system 100 in accordance with the present example embodiment includes a server apparatus 3 and a plurality of client apparatuses 1-1, 1-2, . . . as illustrated in FIG. 3. The information processing system in accordance with the present example embodiment is suitably applicable to, for example, a system for carrying out federated learning. Note, however, that this wording is not intended to limit the present example embodiment.

### (Server Apparatus 3)

The server apparatus 3 includes an acquisition section 31, an aggregation section 32, and a provision section 33 as illustrated in FIG. 3.

### (Acquisition Section 31)

The acquisition section 31 acquires models from the respective plurality of client apparatuses 1-1, 1-2, . . . . Note here that the models acquired from the respective client apparatuses each may be, for example, a trained model obtained by applying a training process to a source model provided in advance by the server apparatus 3. Note that, in the present example embodiment, “acquiring a model” includes, for example, acquiring at least one parameter included in the model (defining the model), or acquiring information pertaining to at least one parameter. For example, the acquisition section 31 may be configured to acquire values of these parameters themselves, or may be configured to acquire an amount of change in these parameters (for example, a difference from the previous step in a case where an iterative process is carried out).

### (Aggregation Section 32)

The aggregation section 32 aggregates the models acquired from the respective plurality of client apparatuses 1-1, 1-2, . . . Details of an aggregation process carried out by the aggregation section 32 are not intended to limit the present example embodiment. For example, by taking a weighted average of parameters acquired from the respective client apparatuses 1-1, 1-2, . . . , a parameter defining a model obtained by aggregation may be derived. Further, the aggregation process carried out by the aggregation section 32 can also be expressed as an “integration process”.

### (Provision Section 33)

The provision section 33 provides each of the plurality of client apparatuses 1-1, 1-2, . . . with a model group including the models aggregated by the aggregation section 32. Note here that, in the present example embodiment, “providing a model or model group” includes, for example, providing at least one parameter included in the model or model group (defining the model or a model included in the model group), or providing information pertaining to at least one parameter. For example, the provision section 33 may be configured to provide values of these parameters themselves, or may be configured to provide an amount of change in these parameters (for example, a difference from the previous step in a case where an iterative process is carried out).

Further, in the present example embodiment, the model group provided by the provision section 33 to a certain client apparatus includes a model acquired from a client apparatus different from the certain client apparatus. For example, the model group provided by the provision section 33 to the client apparatus 1-1 can include a model acquired from the client apparatus 1-2 (in other words, a model trained in the client apparatus 1-2). As described above, in the present example embodiment, a certain client apparatus can refer to a model trained in another client apparatus. In other words, in the present example embodiment, a plurality of client apparatuses each can mutually refer to a model trained in another client apparatus.

### (Client Apparatuses 1-1, 1-2, . . . )

The client apparatuses 1-1, 1-2, . . . each have, for example, a configuration similar to that of the information processing apparatus 1 described in the present example embodiment. Further, as illustrated in FIG. 3, the client apparatuses 1-1, 1-2, . . . each may be configured to include a model acquiring section 15 and a training section 16 in addition to the configuration similar to that of the information processing apparatus 1. In the following description, the configuration included in each of the client apparatuses 1-1, 1-2, . . . may be described with branch numbers such as “−1” and “−2” assigned thereto as appropriate.

For example, the client apparatus 1-1 includes a target data acquiring section 11-1, a model acquiring section 15-1, a reliability level calculating section 12-1, a pseudo label determining section 13-1, and a training section 16-1 as illustrated in FIG. 3. Note here that, since the target data acquiring section 11-1, the reliability level calculating section 12-1, and the pseudo label determining section 13-1 have configurations similar to those of the target data acquiring section 11, the reliability level calculating section 12, and the pseudo label determining section 13, respectively, which are included in the information processing apparatus 1, a description thereof is omitted here.

Similarly, the client apparatus 1-2 includes a target data acquiring section 11-2, a model acquiring section 15-2, a reliability level calculating section 12-2, a pseudo label determining section 13-2, and a training section 16-2 as illustrated in FIG. 3. Note here that, since the target data acquiring section 11-2, the reliability level calculating section 12-2, and the pseudo label determining section 13-2 have configurations similar to those of the target data acquiring section 11, the reliability level calculating section 12, and the pseudo label determining section 13, respectively, which are included in the information processing apparatus 1, a description thereof is omitted here. Note, however, that target data acquired by the respective client apparatuses 1-1, 1-2, . . . can vary from client apparatus to client apparatus.

### (Model Acquiring Section 15)

The model acquiring section 15 acquires a plurality of models included in the model group provided by the server apparatus 3. Note here that the model group acquired by the model acquiring section 15 can include
the models aggregated by the aggregation section 32 of the server apparatus 3 (also referred to as a model obtained by aggregation), and
a model trained in a client apparatus different from a client apparatus to which the model acquiring section 15 belongs. For example, the model group acquired by the model acquiring section 15-1 included in the client apparatus 1-1 can include a model trained in the client apparatus 1-2.

### (Training Section 16)

The training section 16 carries out a machine learning process with reference to the pseudo label determined by the pseudo label determining section 13. For example, the training section 16 refers to the pseudo label determined by pseudo label determining section 13, and trains at least one of the models included in the model group. More specifically, for example, the training section 16-1 included in the client apparatus 1-1 refers to the pseudo label determined by the pseudo label determining section 13, and trains a model obtained by aggregation and acquired from the server apparatus 3. A model trained by the training section 16 is, for example, provided to the server apparatus 3. The model trained by the training section 16 may also be used, for example, for an inference process carried out by a corresponding client apparatus.

### (Flow of Process Carried Out by Information Processing System)

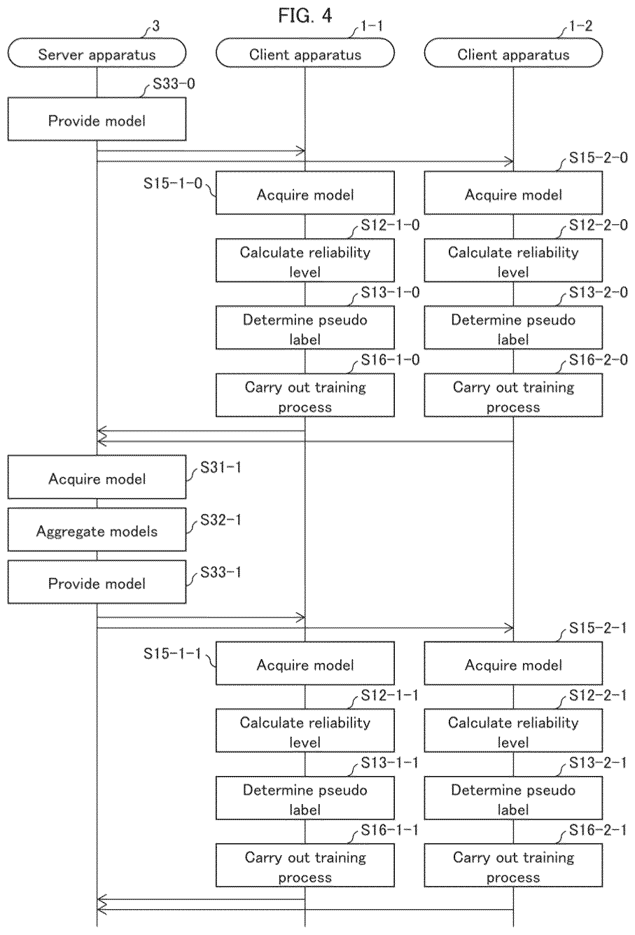

Next, a flow of a process carried out by the information processing system in accordance with the present example embodiment will be described with reference to FIG. 4. FIG. 4 is a flowchart illustrating the flow of the process carried out by the information processing system in accordance with the present example embodiment.

### (Step S33-0)

In step S33-0, the provision section 33 included in the server apparatus 3 provides a model group to each of the client apparatuses 1-1 and 1-2. The model group provided in the present step can include a source model. Note here that the source model is, for example, a model trained with use of source data which can be referred to by the server apparatus 3. Alternatively, the source model may be a model obtained by aggregating (integrating) models that have undergone training processes (updating processes) in the respective client apparatuses.

### (Steps S15-1-0 and S15-2-0)

In step S15-1-0, the model acquiring section 15-1 included in the client apparatus 1-1 acquires the model group provided by the server apparatus 3 to the client apparatus 1-1. Similarly, in step S15-2-0, the model acquiring section 15-2 included in the client apparatus 1-2 acquires the model group provided by the server apparatus 3 to the client apparatus 1-2. Since a specific process carried out by the model acquiring section 15 has been described earlier, a description thereof is omitted here.

### (Steps S12-1-0 and S12-2-0)

Next, in step S12-1-0, by inputting, into at least one of a plurality of pseudo label generating means, at least one of a plurality of models included in the model group acquired by the model acquiring section 15-1 and target data acquired by the target data acquiring section 11-1, the reliability level calculating section 12-1 included in the client apparatus 1-1 calculates a reliability level of the at least one of the plurality of models. For example, from at least one of a plurality of models included in the model group acquired by the model acquiring section 15-1 and target data acquired by the target data acquiring section 11-1, the reliability level calculating section 12-1 calculates a reliability level of the at least one of the plurality of models on the basis of an agreement degree between labels obtained by at least one of a plurality of pseudo label generating means (a plurality of label generating means).

Similarly, in step S12-2-0, by inputting, into at least one of a plurality of pseudo label generating means, at least one of a plurality of models included in the model group acquired by the model acquiring section 15-2 and target data acquired by the target data acquiring section 11-2, the reliability level calculating section 12-2 included in the client apparatus 1-2 calculates a reliability level of the at least one of the plurality of models. For example, from at least one of a plurality of models included in the model group acquired by the model acquiring section 15-2 and target data acquired by the target data acquiring section 11-2, the reliability level calculating section 12-2 calculates a reliability level of the at least one of the plurality of models on the basis of an agreement degree between labels obtained by at least one of a plurality of pseudo label generating means (a plurality of label generating means). Since a specific process carried out by the reliability level calculating section 12 has been described earlier, a description thereof is omitted here.

### (Steps S13-1-0 and S13-2-0)

Subsequently, in step S13-1-0, the pseudo label determining section 13-1 included in the client apparatus 1-1 refers to the reliability level, which has been calculated by the reliability level calculating section 12-1, to determine a pseudo label to be assigned to the target data acquired by the target data acquiring section 11-1.

Similarly, in step S13-2-0, the pseudo label determining section 13-2 included in the client apparatus 1-2 refers to the reliability level, which has been calculated by the reliability level calculating section 12-2, to determine a pseudo label to be assigned to the target data acquired by the target data acquiring section 11-2. Since a specific process carried out by the pseudo label determining section 13 has been described earlier, a description thereof is omitted here.

### (Steps S16-1-0 and S16-2-0)

Next, in step S16-1-0, the training section 16-1 included in the client apparatus 1-1 carries out a training process with reference to the pseudo label determined by the pseudo label determining section 13-1. The client apparatus 1-1 provides the server apparatus 3 with a model obtained by the training process (trained model).

Similarly, in step S16-2-0, the training section 16-2 included in the client apparatus 1-2 carries out a training process with reference to the pseudo label determined by the pseudo label determining section 13-2. The client apparatus 1-2 provides the server apparatus 3 with a model obtained by the training process (trained model). Since a specific process carried out by the training section 16 has been described earlier, a description thereof is omitted here.

### (Steps S31-1, S32-1, and S33-1)

Subsequently, in step S31-1, the acquisition section 31 included in the server apparatus 3 acquires models from the respective client apparatuses 1-1 and 1-2. Then, in step S32-1, the aggregation section 32 included in the server apparatus 3 aggregates the models acquired from the respective client apparatuses 1-1 and 1-2. In step S33-1, the provision section 33 included in the server apparatus 3 provides each of the client apparatuses 1-1 and 1-2 with a model group including the models aggregated by the aggregation section 32.

Thereafter, as illustrated in FIG. 4, a process for acquiring a model, a process for calculating a reliability level, a process for determining a pseudo label, and a training process are carried out in each of the client apparatuses 1-1 and 1-2, and a trained model is provided to the server apparatus 3 again.

### (Effect of Information Processing System)

As described above, a configuration is employed such that the information processing system in accordance with the present example embodiment is an information processing system including a server apparatus 3 and a plurality of client apparatuses 1, 2, . . . ,
the server apparatus 3
acquiring models from the respective plurality of client apparatuses,
aggregating the models acquired from the respective plurality of client apparatuses, and
providing each of the plurality of client apparatuses with a model group including the aggregated models, the plurality of client apparatuses 1, 2, . . . each
acquiring a plurality of models included in the model group provided by the server apparatus 3,
acquiring target data,
by inputting at least one of the plurality of models and the target data into at least one of a plurality of pseudo label generating means, calculating a reliability level of the at least one of the plurality of models,
referring to the reliability level to determine a pseudo label to be assigned to the target data, and
carrying out a training process with reference to the determined pseudo label.

The information processing system configured as described above brings about an effect similar to that brought about by the information processing apparatus 1 in accordance with the present example embodiment.

Further, according to the above configuration, by inputting, into at least one of a plurality of pseudo label generating means, the target data and at least one of a plurality of models included in a model group including a model trained in another client apparatus, a reliability level of the at least one of the plurality of models is calculated. Thus, a model trained in a client apparatus (another client apparatus) different from a certain client apparatus can be suitably used in calculation of a reliability level. Thus, as compared with a case where a pseudo label is generated with reference to only a model to be trained in a certain client apparatus, it is possible to further improve a reliability level of a pseudo label. For example, in a case where the above-described information processing system is applied to federated learning, a highly reliable pseudo label can be suitably generated in each client apparatus.

### Second Example Embodiment

The following description will discuss a second example embodiment, which is an example embodiment of the present invention, in detail with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the technical means which are employed in the present example embodiment can be employed also in the other example embodiments included in the present disclosure, provided that no particular technical problem occurs. Moreover, technical means which are indicated in the drawings referred to for describing the present example embodiment can be employed also in the other example embodiments included in the present disclosure, provided that no particular technical problem occurs.

(Configuration of information processing apparatus 1A)

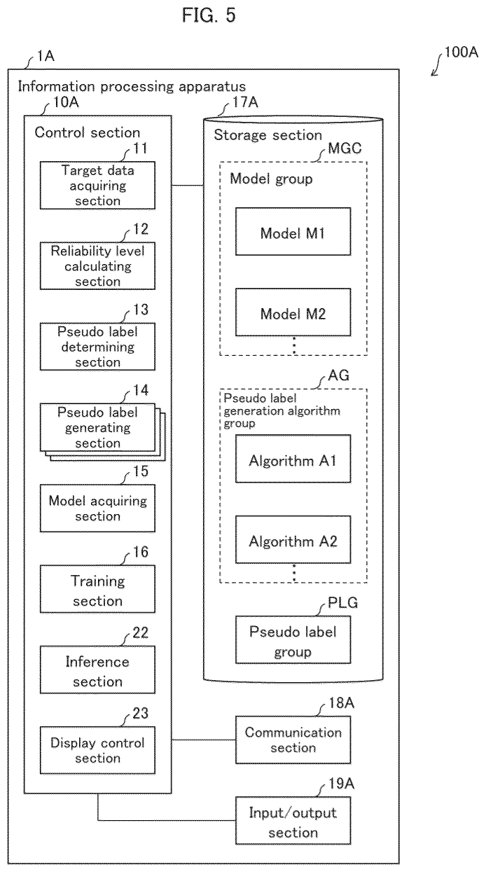

A configuration of an information processing apparatus 1A in accordance with the present example embodiment will be described with reference to FIG. 5. FIG. 5 is a block diagram illustrating the configuration of the information processing apparatus 1A. The information processing apparatus 1A includes a control section 10A, a storage section 17A, a communication section 18A, and an input/output section 19A as illustrated in FIG. 5. Note that, also in the present example embodiment, the wording “pseudo label” is not intended to limit the present example embodiment. As in the case of the first example embodiment, the present example embodiment also includes a configuration obtained by reading the wording “pseudo label” as “label”.

The communication section 18A communicates with an external apparatus outside the information processing apparatus 1A. The communication section 18A transmits, to the external apparatus, data supplied from the control section 10A, and supplies, to the control section 10A, data received from the external apparatus.

The input/output section 19A is configured to include at least any of input/output apparatuses such as a keyboard, a mouse, a display, a printer, and a touch panel. Alternatively, at least any of input/output apparatuses such as a keyboard, a mouse, a display, a printer, and a touch panel may be configured to be connected to the input/output section 19A. In the case of such a configuration, the input/output section 19A accepts, from an input apparatus connected thereto, input of various pieces of information with respect to the information processing apparatus 1A. The input/output section 19A outputs, to an output apparatus(es) connected thereto, various pieces of information under control by the control section 10A. Examples of the input/output section 19A include interfaces such as a universal serial bus (USB).

### (Storage Section 17A)

In the storage section 17A, various pieces of data that are referred to by the control section 10A and various pieces of data that have been generated by the control section 10A are stored. For example, in the storage section 17A, a model group MGC, a pseudo label generation algorithm group AG, and a pseudo label group PLG are stored.

### (Model Group MGC)

The model group MGC includes a plurality of models (denoted as models M1, M2, . . . in FIG. 5) that are used to calculate a pseudo label to be assigned to target data. The model group MGC may also include a model to be subjected to a training process carried out by a training section 16. Further, the model to be subjected to the training process may or need not be any of the plurality of models (models M1, M2, . . . ) that are used to calculate the pseudo label.

Note that the wording “model” can include the meaning of “at least one parameter defining a model”. Further, although a specific configuration of each of the models included in the model group MGC is not intended to limit the present example embodiment, a model can be, for example, any of a convolutional neural network (CNN), a recurrent neural network (RNN), and a combination of these.

### (Pseudo Label Generation Algorithm Group AG)

The pseudo label generation algorithm group AG includes at least one selected from the group consisting of a plurality of pseudo label generation algorithms (algorithms A1, A2, . . . in FIG. 5), each of which functions as a pseudo label generating means, information defining the pseudo label generation algorithms, and information for executing the pseudo label generation algorithms. The pseudo label generation algorithms are each, for example, an algorithm that uses data and a model as input and that uses the model to generate a pseudo label to be assigned to the data.

For example, the pseudo label generation algorithms are executed in the form of a program by a respective plurality of pseudo label generating sections 14 (described later). Further, the information defining each of the pseudo label generation algorithms may be configured to include information pertaining to, for example, the following:
output from which of a plurality of layers included in the above model to refer to; and
by what process to carry out with respect to the output from a corresponding one of the plurality of layers to generate a pseudo label. The algorithms included in the pseudo label generation algorithm group AG are, for example, algorithms that are different from each other.

### (Pseudo Label Group PLG)

The pseudo label group PLG includes at least one selected from the group consisting of pseudo labels generated by the plurality of pseudo label generating sections 14 (described later) and a pseudo label determined by a pseudo label determining section 13. A pseudo label generated by each of the pseudo label generating sections 14 or the pseudo label determined by the pseudo label determining section 13 includes, for example, a pseudo label that can be assigned to each part (each data piece) included in the target data. In other words, in a case where the target data includes N data pieces (for example, N target images), the pseudo label generated by each of the pseudo label generating sections 14 or the pseudo label determined by the pseudo label determining section 13 includes a pseudo label that can be assigned to each of these N data pieces.

For example, in a case where the target data includes an image 1, an image 2, and an image 3, the pseudo label generated by each of the pseudo label generating sections 14 or the pseudo label determined by the pseudo label determining section 13 includes a pseudo label 1 that can be assigned to the image 1, a pseudo label 2 that can be assigned to the image 2, and a pseudo label 3 that can be assigned to the image 3.

### (Control Section 10A)

The control section 10A includes a target data acquiring section 11, a reliability level calculating section 12, a pseudo label determining section 13, the plurality of pseudo label generating sections 14, a model acquiring section 15, a training section 16, an inference section 22, and a display control section 23 as illustrated in FIG. 5.

### (Target Data Acquiring Section 11)

As in the case of the first example embodiment, the target data acquiring section 11 acquires data (target data) to be processed by the information processing apparatus 1A. Note here that examples of the target data include data without a ground-truth label (also called a training label). Further, although a type of data included in the target data is not particularly limited, the data can be, for example, any of image data, text data, and sensor ring data.

### (Model Acquiring Section 15)

The model acquiring section 15 acquires a plurality of models. For example, the model acquiring section 15 may acquire a plurality of models input by a user via the input/output section 19A, or may acquire a plurality of models from another apparatus. The plurality of models (models M1, M2, . . . ) acquired by the model acquiring section 15 are stored, as, for example, part of the foregoing model group MGC, in the storage section 17A and referred to by the reliability level calculating section 12.

Note here that the plurality of models can include, for example, a model which uses the target data as input to output an inference result (estimation result, prediction result) for the target data. However, this is not intended to limit the present example embodiment.

Note that the model acquiring section 15 may carry out a process for providing another apparatus with a model that is at least one of the plurality of models included in the model group MGC and that has undergone the training process carried out by the training section 16. In other words, the model acquiring section 15 also functions as a model transmitting and receiving means for carrying out at least one selected from the group consisting of:
a process for acquiring, from another apparatus, at least one of the plurality of models; and
a process for providing at least one of the plurality of models to another apparatus.

### (Reliability Level Calculating Section 12)

By inputting at least one of a plurality of models acquired by the model acquiring section 15 and the target data into at least one of a plurality of pseudo label generating means, the reliability level calculating section 12 calculates a reliability level of the at least one of the plurality of models. For example, from at least one of a plurality of models and the target data, the reliability level calculating section 12 calculates a reliability level of the at least one of the plurality of models on the basis of an agreement degree between labels obtained by at least one of a plurality of pseudo label generating means (a plurality of label generating means).

Note here that the plurality of pseudo label generating means are realized by, for example, the foregoing plurality of pseudo label generation algorithms. Alternatively, the plurality of pseudo label generating means may be expressed as being realized by the plurality of pseudo label generating sections 14 that execute the respective foregoing plurality of pseudo label generation algorithms.

Further, for example, the reliability level calculating section 12 may be configured to assign, to a first model among the plurality of models, a reliability level in accordance with a degree of agreement (agreement degree) between
a first pseudo label obtained by inputting the first model and the target data into a first pseudo label generating means among the plurality of pseudo label generating means and
a second pseudo label obtained by inputting the first model and the target data into a second pseudo label generating means among the plurality of pseudo label generating means. Alternatively, the reliability level calculating section 12 may be configured to refer to:
   a first degree of agreement (first agreement degree), which is a degree of agreement between
a first pseudo label obtained by inputting a first model among the plurality of models and the target data into a first pseudo label generating means among the plurality of pseudo label generating means and
a second pseudo label obtained by inputting the first model and the target data into a second pseudo label generating means among the plurality of pseudo label generating means; and
   a second degree of agreement (second agreement degree), which is a degree of agreement between
a third pseudo label obtained by inputting a second model among the plurality of models and the target data into the first pseudo label generating means and
a fourth pseudo label obtained by inputting the second model and the target data into the second pseudo label generating means, and
   assign a higher reliability level to the first model than to the second model in a case where the first degree of agreement is higher than the second degree of agreement. Note, however, that the above example is not intended to limit the present example embodiment. A more specific example reliability level calculating process carried out by the reliability level calculating section 12 will be described later.

### (Pseudo Label Determining Section 13)

As in the case of the first example embodiment, the pseudo label determining section 13 refers to the reliability level, which has been calculated by the reliability level calculating section 12, to determine a pseudo label to be assigned to the target data. For example, the pseudo label determining section 13 determines, as the pseudo label to be assigned to the target data, a pseudo label generated with use of at least one model that is among the foregoing plurality of models and that has a higher reliability level. Note here that, as in the case of the first example embodiment, “a higher reliability level” may be, for example, “a reliability level higher than a predetermined threshold” or may be “a relatively high reliability level among respective reliability levels of the plurality of models”.

For example, in a case where a predetermined threshold is 80%, and the reliability level calculating section 12 calculates, for a model A, a reliability level of 90%, which is higher than the predetermined threshold, the pseudo label determining section 13 may determine, as the pseudo label to be assigned to the target data, a pseudo label generated with use of the model A.

Alternatively, in a case where the reliability level calculating section 12 calculates reliability levels of 70%, 80%, and 30% for the model A, a model B, and a model C, respectively, the pseudo label determining section 13 may determine, as the pseudo label to be assigned to the target data, a pseudo label generated with use of the models A and B that have relatively high reliability levels.

Further, the pseudo label determining section 13 may
generate a pseudo label by inputting, into at least one of the foregoing plurality of label generating means, the foregoing target data and each of at least one model that is among the foregoing plurality of models and that has a higher reliability level, and
determine the generated pseudo label as the pseudo label to be assigned to the target data.

In other words, the pseudo label determining section 13
may be configured to select, as the pseudo label to be assigned to the target data, a pseudo label generated by inputting, into the at least one of the plurality of pseudo label generating means, the target data and a model that has a higher reliability level among reliability levels calculated by the reliability level calculating means for the respective plurality of models, or
may be configured to, by inputting, into the at least one of the pseudo label generating means, the target data and each of models each of which has a higher reliability level among reliability levels calculated by the reliability level calculating means for the respective plurality of models, generate the pseudo label to be assigned to the target data. Note, however, that these specific examples are not intended to limit the present example embodiment. A more specific example pseudo label determining process carried out by the pseudo label determining section 13 will be described later.

### (Pseudo Label Generating Section 14)

The control section 10A includes the plurality of pseudo label generating sections 14 as illustrated in FIG. 5. For example, by executing the foregoing pseudo label generation algorithms, the pseudo label generating sections 14 each generate a pseudo label related to the target data. As described earlier, the pseudo label generation algorithms are each, for example, an algorithm that uses target data and at least one of a plurality of models (models M1, M2, . . . ) as input and that uses the at least one of the plurality of models to generate a pseudo label to be assigned to the target data. A pseudo label generating section 14 acquires the target data and the at least one of the plurality of models, and uses the target data and the at least one of the plurality of models as input into a pseudo label generation algorithm.

The pseudo label generated by the pseudo label generating section 14 is, for example, referred to for calculation of the reliability level by the reliability level calculating section 12. Further, the pseudo label generated by the pseudo label generating section 14 serves as, for example, a candidate for the pseudo label to be determined by the pseudo label determining section 13. Note that the plurality of pseudo label generating sections 14 are also denoted as, for example, pseudo label generating sections 14-1, 14-2, . . . .

### (Training Section 16)

The training section 16 refers to the label determined by pseudo label determining section 13, and carries out a machine learning process related to at least one of the plurality of models included in the model group. For example, the training section 16 uses supervised learning with reference to the pseudo label determined by the pseudo label determining section 13 to train the at least one of the models.

### (Inference Section 22)

The inference section 22 carries out an inference process in which a model trained by the training process carried out by the training section 16 is used. For example, the inference section 22 carries out the inference process with reference to data that has been acquired by the target data acquiring section 11 and that is to be subjected to the inference process.

### (Display Control Section 23)

The display control section 23 presents, to the user via a display or the like included in the input/output section 19A, data for display which data includes at least one selected from the group consisting of information referred to by the control section 10A and information derived by the control section 10A. For example, the display control section 23 functions also as a display means for displaying at least one selected from the group consisting of:
the reliability level that has been calculated by the reliability level calculating section 12; and
information that has been obtained with use of a model which has been trained by machine learning with reference to the pseudo label and that supports decision making by the user.

Further, the display control section 23 may be configured to:
generate a graphical user interface (GUI) that presents the user with, in addition to the reliability level, model information indicating a plurality of models for each of which the reliability level has been calculated;
acquire selection information from the user pertaining to which of the plurality of models is to be used for the pseudo label determining process; and
supply the acquired selection information to the pseudo label determining section 13. Furthermore, in the case of such a configuration, the pseudo label determining section 13 may further refer to the selection information to determine a pseudo label to be assigned to the target data.

The information processing apparatus 1A configured as described above makes it possible to generate a highly reliable pseudo label as in the case of the information processing apparatus 1 in accordance with the first example embodiment. Further, it is possible to suitably carry out a training process with reference to data to which a highly reliable pseudo label is thus assigned. Furthermore, it is possible to use a model thus trained to suitably carry out an inference process.

### (Example Process 1 Carried Out by Information Processing Apparatus 1A)

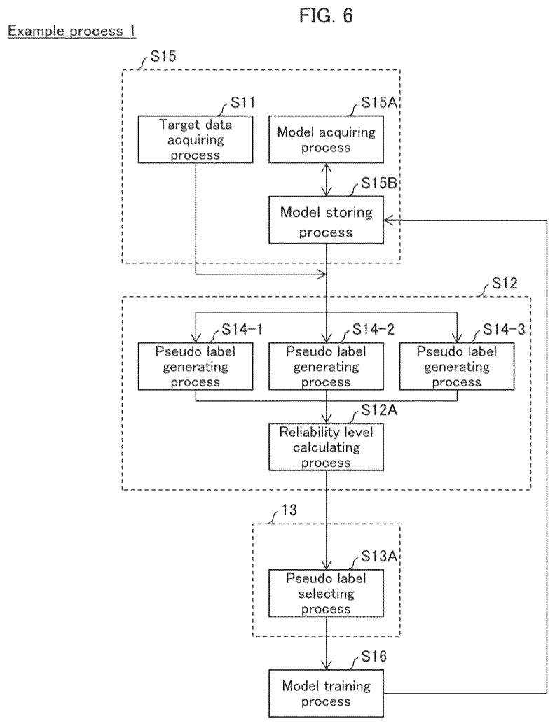

A flow of a specific process carried out by the information processing apparatus 1A is described below with reference to different drawings. FIG. 6 is a diagram for describing an example process 1 carried out by the information processing apparatus 1A. As illustrated in FIG. 6, the information processing apparatus 1A carries out an acquisition process S15, a reliability level calculating process S12, a pseudo label determining process S13, and a model training process S16 in the present example process.

(Acquisition process S15)

The acquisition process S15 includes a target data acquiring process S11, a model acquiring process S15A, and a model storing process S15B. The target data acquiring process S11 is, for example, a process that is carried out by the target data acquiring section 11, and target data is acquired. The model acquiring process S15A is, for example, a process that is carried out by the model acquiring section 15, and a plurality of models are acquired. The model storing process S15B is, for example, a process that is carried out by the model acquiring section 15, and the acquired plurality of models are stored in the storage section 17A as part of the model group MGC. Since specific processes related to these sections have been described earlier, a description thereof is omitted here.

### (Reliability Level Calculating Process S12)

The reliability level calculating process S12 includes a plurality of pseudo label generating processes S14-1, S14-2, and S14-3 and a reliability level calculating process S12A with reference to results of these pseudo label generating processes. Note here that the plurality of pseudo label generating processes S14-1, S14-2, and S14-3 are each a pseudo label generation algorithm and are realized by algorithms which are different from each other.

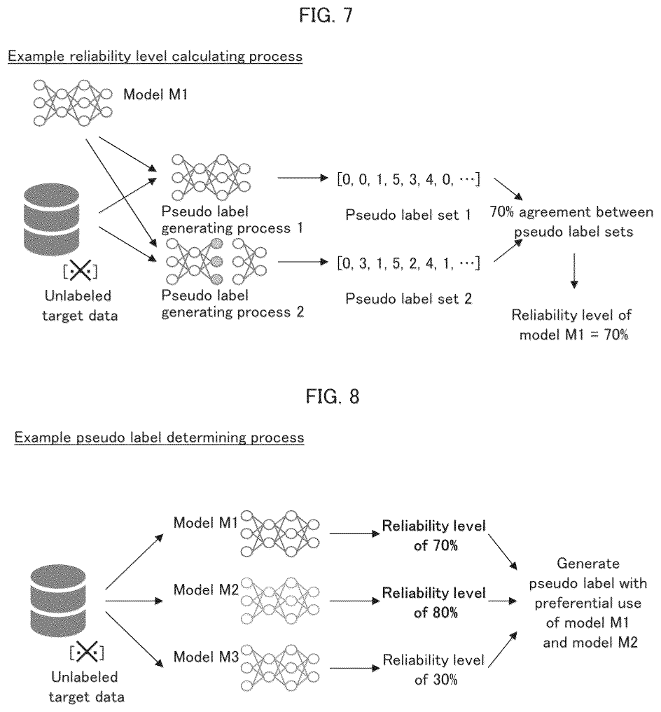

FIG. 7 is a diagram for describing a specific example process as the reliability level calculating process S12. As illustrated in FIG. 7, unlabeled target data (target data acquired by the target data acquiring process S11) and the model M1 (one of the plurality of models acquired by the model storing process S15B) are input into a pseudo label generating process 1 (corresponding to the pseudo label generating process S14-1) and a pseudo label generating process 2 (corresponding to the pseudo label generating process S14-2). In other words, the pseudo label generating section 14-1 carries out the pseudo label generating process 1 with reference to the target data and the model M1, and the pseudo label generating section 14-2 carries out the pseudo label generating process 2 with reference to the target data and the model M1.

FIG. 7 illustrates an example in which a pseudo label set 1 [0, 0, 1, 5, 3, 4, 0, . . . ] is generated by the pseudo label generating process 1, and a pseudo label set 2 [0, 3, 1, 5, 2, 4, 1, . . . ] is generated by the pseudo label generating process 2. In the reliability level calculating process S12A, an agreement degree between these pseudo label sets is determined, and a reliability level in accordance with the agreement degree is assigned to the model M1, which is the model input into the pseudo label generating processes. In the example illustrated in FIG. 7, in a case where the agreement degree between the pseudo label set 1 and the pseudo label set 2 is 70%, a reliability level of 70% is assigned to the model M1.

The above-described process in the reliability level calculating process S12A can be expressed as assigning, to a first model (model M1) among the plurality of models, a reliability level in accordance with a degree of agreement (agreement degree) between
a first pseudo label (pseudo label set 1) obtained by inputting the first model (model M1) and the target data into a first pseudo label generating means (pseudo label generating process 1) among the plurality of pseudo label generating means and
a second pseudo label (pseudo label set 2) obtained by inputting the first model (model M1) and the target data into a second pseudo label generating means (pseudo label generating process 2) among the plurality of pseudo label generating means.

Further, in the reliability level calculating process S12A, such a process as described above is carried out with respect to each of the plurality of models included in the model group MGC. For example, the reliability level calculating process S12A may be configured to carry out a process with respect to the model M1 and a process with respect to the model M2, refer to:
a first degree of agreement (first agreement degree), which is a degree of agreement between
a first pseudo label (pseudo label set 1) obtained by inputting the first model (model M1) and the target data into a first pseudo label generating means (pseudo label generating process 1) among the plurality of pseudo label generating means and
a second pseudo label (pseudo label set 2) obtained by inputting the first model (model M1) and the target data into a second pseudo label generating means (pseudo label generating process 2) among the plurality of pseudo label generating means; and a second degree of agreement (second agreement degree), which is a degree of agreement between
a third pseudo label (pseudo label set 3) obtained by inputting a second model (model M2) among the plurality of models and the target data into the first pseudo label generating means (pseudo label generating process 1) and
a fourth pseudo label (pseudo label set 4) obtained by inputting the second model (model M2) and the target data into the second pseudo label generating means (pseudo label generating process 2), and
assign a higher reliability level to the first model (model M1) than to the second model (model M2) in a case where the first degree of agreement is higher than the second degree of agreement. The reliability level calculating process S12A as described above makes it possible to suitably calculate the reliability level of the model.

Note that specific content of the reliability level calculating process S12 carried out by the reliability level calculating section 12 is not limited to the above example. For example, the reliability level calculating section 12 may use a plurality of data pieces (xⁱ, i=1, 2, 3, . . . ) included in the target data and pseudo labels (yⁱ, i=1, 2, 3, . . . ) generated by the pseudo label generating means for the respective data pieces to generate a mixed sample by xₘᵢₓ=λxⁱ+(1−λ)x^{j}, generate a mixed pseudo label by yₘᵢₓ=λyⁱ+(1−λ)y^{j}, carry out interpolation consistency evaluation with use of the mixed sample and the mixed pseudo label, and use a result of the interpolation consistency evaluation as a reliability level. Note that the result of the interpolation consistency evaluation is an example of “an agreement degree between labels obtained by a plurality of label generating means”.

### (Pseudo Label Determining Process S13)

In the pseudo label determining process S13 carried out by the pseudo label determining section 13, a pseudo label to be assigned to target data is determined with reference to a reliability level assigned to each of the plurality of models. The pseudo label determining process S13 includes, for example, a pseudo label selecting process S13A as illustrated in FIG. 6. Note here that the pseudo label selecting process S13A is a process in which, from a plurality of pseudo label sets generated with use of a plurality of models in the reliability level calculating process S12, the pseudo label to be assigned to the target data is selected in accordance with a reliability level of each of the plurality of models.

FIG. 8 illustrates an example case where the pseudo label determining section 13 calculates a reliability level of 70% for the model M1, calculates a reliability level of 80% for the model M2, and calculates a reliability level of 30% for the model M3. In such a situation, the pseudo label determining section 13 generates a pseudo label with preferential use of the models (models M1 and M2) that have higher reliability levels (70% and 80%) among the reliability levels (70%, 80%, and 30%) calculated by the reliability level calculating means for the respective plurality of models.

For example, the pseudo label determining section 13 selects, as the pseudo label to be assigned to the target data, a pseudo label generated by inputting, into at least one of the plurality of pseudo label generating means, the target data and the foregoing single model (M2) that has a higher reliability level (80%).

Alternatively, the pseudo label determining section 13 may select, as the pseudo label to be assigned to the target data, a pseudo label generated by inputting, into at least one of the plurality of pseudo label generating means, the target data and each of the foregoing plurality of models (M1 and M2) that have higher reliability levels (70% and 80%).

For example, the pseudo label determining section 13 may assign, to the target data, a pseudo label obtained by a weighted sum of (i) the first pseudo label (pseudo label set 1) obtained by inputting the target data and the model M1 into the foregoing pseudo label generating process 1 and (ii) the second pseudo label (pseudo label set 2) obtained by inputting the target data and the model M2 into the foregoing pseudo label generating process 1. Note here that a weighting factor which is used in the weighted sum may be determined so as to have a positive correlation with reliability levels of target models (the models M1 and M2 in the above example).

More specifically, a configuration may be such that, in a case where a reliability level of 70% is assigned to the model M1, and a reliability level of 80% is assigned to the model M2, a weighting factor by which the pseudo label set 1 is multiplied is calculated by 70/(70+80), and a weighting factor by which the pseudo label set 2 is multiplied is calculated by 80/(70+80).

The above configuration makes it possible to suitably determine, with reference to a reliability level assigned to each of the plurality of models, a pseudo label to be assigned to target data.

### (Training Process S16)

The training process S16 is a process that is carried out by the training section 16, and is a training process that is carried out, with reference to the pseudo label determined by the pseudo label determining section 13, with respect to the at least one of the plurality of models included in the model group. Since a specific example of the training process has been described earlier, a description thereof is omitted here. For example, the model that has undergone the training process S16 is stored in the storage section 17A by the model storing process S15B and is to be subjected to a further pseudo label determining process, a further training process, and the like.

### (Example Process 2 Carried Out by Information Processing Apparatus 1A)

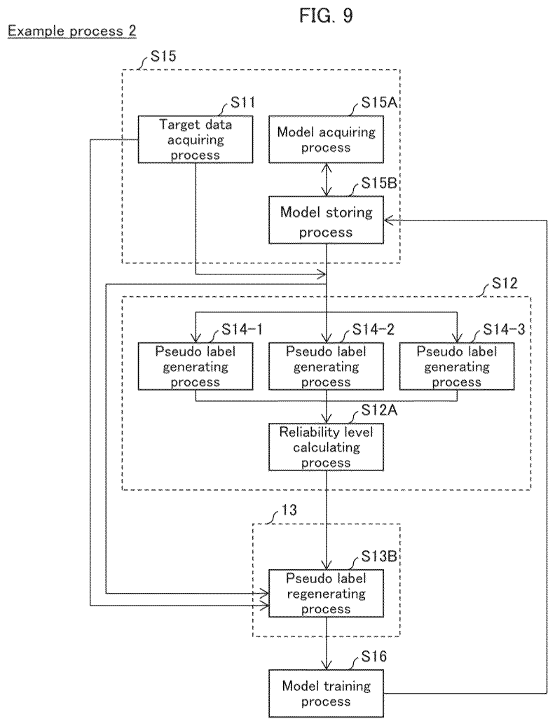

FIG. 9 is a diagram for describing an example process 2 carried out by the information processing apparatus 1A. As illustrated in FIG. 9, the information processing apparatus 1A carries out the acquisition process S15, the reliability level calculating process S12, the pseudo label determining process S13, and the model training process S16 also in the present example process. Since the processes except the pseudo label determining process S13 are similar to those in the example process 1, a description thereof is omitted here.

### (Pseudo Label Determining Process S13)

As illustrated in FIG. 9, the pseudo label determining process S13 includes a pseudo label regenerating process S13B in the present example. Note here that the pseudo label regenerating process S13B is a process for, by inputting, into the at least one of the pseudo label generating means, the target data and each of models each of which has a higher reliability level among reliability levels calculated by the reliability level calculating section 12 for the respective plurality of models, generating the pseudo label to be assigned to the target data.

For example, in a case where the pseudo label determining section 13 calculates a reliability level of 70% for the model M1, calculates a reliability level of 80% for the model M2, and calculates a reliability level of 30% for the model M3, the pseudo label determining section 13 may use
a pseudo label obtained by inputting the target data and the model M1 into a pseudo label generating process 3 different from either the pseudo label generating process 1 or the pseudo label generating process 2 and
a pseudo label obtained by inputting the target data and the model M2 into a pseudo label generating process 4 different from any of the pseudo label generating process 1, the pseudo label generating process 2, and the pseudo label generating process 3 to generate the pseudo label to be assigned to the target data.

Note that the pseudo label determining process in accordance with the present example is not limited to the above example. For example,
a reliability level assigned to each model or a numerical value obtained by converting the reliability level may be set as a weighting factor,
the above weighting factor may be used to perform weighted average calculation of a probability distribution indicated by each pseudo label obtained with use of each model, and
the probability distribution having been subjected to weighted average calculation may be used as the pseudo label to be assigned to the target data.

Alternatively,
a reliability level assigned to each model or a numerical value obtained by converting the reliability level may be set as a weighting factor,
the weighting factor may be used to perform weighted average calculation (weighted joining) of output from an intermediate layer of each of the foregoing plurality of models, and
the probability distribution having been subjected to weighted average calculation (weighted joining) may be used as the pseudo label to be assigned to the target data.

The above configuration also makes it possible to suitably determine, with reference to a reliability level assigned to each of the plurality of models, a pseudo label to be assigned to target data.

### Third Example Embodiment

The following description will discuss a third example embodiment, which is an example embodiment of the present invention, in detail with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the technical means which are employed in the present example embodiment can be employed also in the other example embodiments included in the present disclosure, provided that no particular technical problem occurs. Moreover, technical means which are indicated in the drawings referred to for describing the present example embodiment can be employed also in the other example embodiments included in the present disclosure, provided that no particular technical problem occurs.

### (Configuration of Information Processing System 100B)

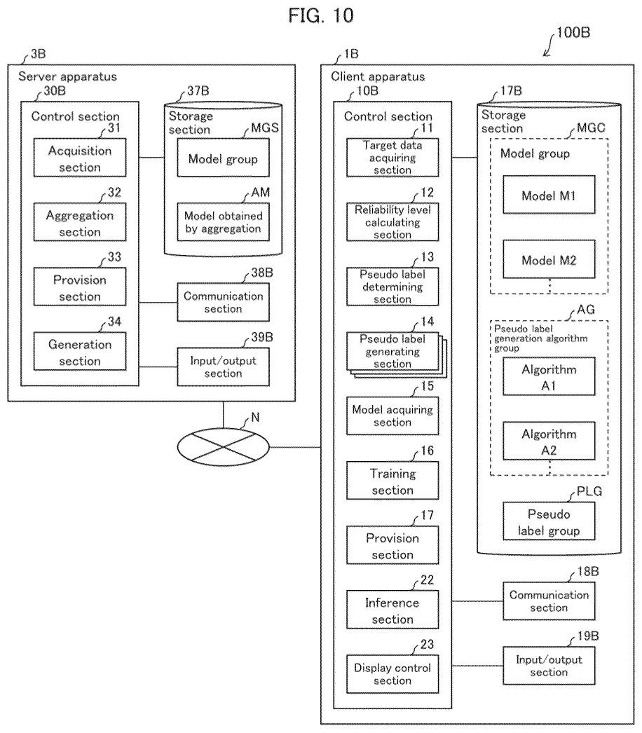

A configuration of an information processing system 100B in accordance with the present example embodiment will be described with reference to FIG. 10. FIG. 10 is a block diagram illustrating the configuration of the information processing system 100B. The information processing system 100B is configured to include a server apparatus 3B and a client apparatus (information processing apparatus) 1B as illustrated in FIG. 10. Further, the server apparatus 3B and the client apparatus 1B are connected via a network N so as to be capable of communicating with each other, as illustrated in FIG. 10. Note here that, although a specific configuration of the network N is not intended to limit the present example embodiment, the network N can be, for example, a wireless local area network (LAN), a wired LAN, a wide area network (WAN), a public network, a mobile data communication network, or any combination of these networks.

FIG. 10 illustrates only one client apparatus 1B in terms of presentation. Note, however, that this is not intended to limit the present example embodiment, but the information processing system 100B may include a plurality of client apparatuses (information processing apparatuses) which have functions similar to those of the client apparatus 1B. These client apparatuses are sometimes denoted as client apparatuses 1B. Further, in a case where the client apparatuses are specified and described, the client apparatuses are sometimes denoted, with use of branch numbers, as a client apparatus 1B-1, a client apparatus 1B-2, . . . The client apparatuses are alternatively sometimes denoted as a client apparatus 1B, a client apparatus 2B, . . . Note that, also in the present example embodiment, the wording “pseudo label” is not intended to limit the present example embodiment. As in the case of the first and second example embodiments, the present example embodiment also includes a configuration obtained by reading the wording “pseudo label” as “label”.

### (Server Apparatus 3B)

The server apparatus 3B includes a control section 30B, a storage section 37B, a communication section 38B, and an input/output section 39B as illustrated in FIG. 10. The control section 30B controls sections included in the server apparatus 3B.

The communication section 38B communicates with an external apparatus outside the server apparatus 3B. For example, the communication section 38B communicates with the client apparatus 1B. The communication section 38B transmits, to the client apparatus 1B, data supplied from the control section 30, and supplies, to the control section 30B, data received from the client apparatus 1B. Note that data which is provided by the communication section 38B to the client apparatus 1B includes, for example, an initial model generated by a generation section 34 (described later) or a model obtained by aggregation and generated by the aggregation section 32. Note that a model which is provided by the server apparatus 3B to each of the client apparatuses 1B is sometimes referred to as a source model.

In the present example embodiment, the data which is provided by the communication section 38B to a client apparatus 1B can also include a model acquired from at least one client apparatus that belongs to the information processing system 100B and that is different from the client apparatus 1B (in other words, a model trained in the at least one client apparatus).

Also in the present example embodiment, the wording “model” can include the meaning of “at least one parameter defining a model”. Thus, the data which is provided by the communication section 38B to the client apparatus 1B includes, for example, at least one parameter defining the initial model generated by the generation section 34 (described later) or at least one parameter defining the model obtained by aggregation and generated by the aggregation section 32.

Data which is received by the communication section 38B from the client apparatus 1B includes, for example, a model updated by each of the client apparatuses 1B. In other words, the data which is received by the communication section 38B from the client apparatus 1B includes, for example, at least one parameter defining the model updated by each of the client apparatuses 1B.

The input/output section 39B is configured to include at least any of input/output apparatuses such as a keyboard, a mouse, a display, a printer, and a touch panel. Alternatively, at least any of input/output apparatuses such as a keyboard, a mouse, a display, a printer, and a touch panel may be configured to be connected to the input/output section 39B. In the case of such a configuration, the input/output section 39B accepts, from an input apparatus connected thereto, input of various pieces of information with respect to the server apparatus 3B. The input/output section 39B outputs, to an output apparatus(es) connected thereto, various pieces of information under control by the control section 30B. Examples of the input/output section 39B include interfaces such as a universal serial bus (USB).

### (Control Section 30B)

The control section 30B of the server apparatus 3B includes an acquisition section 31, an aggregation section 32, a provision section 33, and a generation section 34 as illustrated in FIG. 10.

### (Acquisition Section 31)

The acquisition section 31 acquires models from the respective plurality of client apparatuses 1B-1, 1B-2, . . . For example, the models acquired by the acquisition section 31 are stored in the storage section 37B. Note here that, as described in the first example embodiment, the models acquired from the respective client apparatuses each may be, for example, a trained model obtained by applying a training process to a source model provided in advance by the server apparatus 3B. Note that, also in the present example embodiment, “acquiring a model” includes, for example, acquiring at least one parameter included in the model (defining the model), or acquiring information pertaining to at least one parameter. For example, the acquisition section 31 may be configured to acquire values of these parameters themselves, or may be configured to acquire an amount of change in these parameters (for example, a difference from the previous step in a case where an iterative process is carried out).

Further, the acquisition section 31 may be configured to acquire pre-training data that is referred to by the generation section 34 (described later) for generating a pre-trained model. Note here that the pre-training data can include, for example, target data which is input into a model to be pre-trained and a ground-truth label associated with the target data.

### (Aggregation Section 32)

The aggregation section 32 aggregates the models acquired from the respective client apparatuses 1B. A model obtained by aggregation and generated by an aggregation process carried out by the aggregation section 32 is, for example, stored in the storage section 37B. Details of the aggregation process carried out by the aggregation section 32 are not intended to limit the present example embodiment. For example, by taking a weighted average of parameters acquired from the respective client apparatuses 1B, a parameter defining the model obtained by aggregation may be derived. The aggregation section 32 may also be configured to generate, with further reference to feature information acquired from each of the client apparatuses 1B, the model obtained by aggregation.

### (Provision Section 33)

The provision section 33 provides each of the plurality of client apparatuses 1B-1, 1B-2, . . . with a model group including the models aggregated by the aggregation section 32. In the present example embodiment, as described earlier, the model group provided by the provision section 33 to a certain client apparatus includes a model acquired from a client apparatus different from the certain client apparatus. For example, the model group provided by the provision section 33 to the client apparatus 1B-1 can include a model acquired from the client apparatus 1B-2 (in other words, a model trained in the client apparatus 1B-2). As described above, in the present example embodiment, a certain client apparatus can refer to a model trained in another client apparatus. In other words, in the present example embodiment, a plurality of client apparatuses each can mutually refer to a model trained in another client apparatus.

### (Generation Section 34)

The generation section 34 generates a pre-trained model to be provided to each of the client apparatuses 1B. For example, the generation section 34 generates the pre-trained model by a training process with reference to pre-training data. Note here that the pre-training data may be, for example, the pre-training data acquired by the acquisition section 31. Note also that the pre-training data may include target data and a ground-truth label associated with the target data. By inputting target data into a model to be pre-trained, and updating the model so that a difference between output of the model and a ground-truth label is reduced, the generation section 34 can train the model. Note that, although a type of the pre-trained model is not intended to limit the present example embodiment, the pre-trained model can be, for example, any of a convolutional neural network (CNN), a recurrent neural network (RNN), and a combination of these.

### (Client Apparatus (Information Processing Apparatus) 1B)

The client apparatus (information processing apparatus) 1B includes a control section 10B, a storage section 17B, a communication section 18B, and an input/output section 19B as illustrated in FIG. 10.

The communication section 18B communicates with an apparatus outside the client apparatus 1B. For example, the communication section 18B communicates with the server apparatus 3B. The communication section 18B transmits, to the server apparatus 3B, data supplied from the control section 10B, and supplies, to the control section 10B, data received from the server apparatus 3B. The data which is received by the communication section 18B from the server apparatus 3B can include, for example, at least one selected from the group consisting of the pre-trained model generated by the generation section 34, the model obtained by aggregation and generated by the aggregation section 32, and a model acquired by the server apparatus 3B from another client apparatus.

Further, the data which is provided by the communication section 18B to the server apparatus 3B can include, for example, a trained model obtained from the server apparatus 3B by applying, to the above model, a training process carried out by a training section 16.

The input/output section 19B is configured to include at least any of input/output apparatuses such as a keyboard, a mouse, a display, a printer, and a touch panel. Alternatively, at least any of input/output apparatuses such as a keyboard, a mouse, a display, a printer, and a touch panel may be configured to be connected to the input/output section 19B. In the case of such a configuration, the input/output section 19B accepts, from an input apparatus connected thereto, input of various pieces of information with respect to the client apparatus 1B. The input/output section 19B outputs, to an output apparatus(es) connected thereto, various pieces of information under control by the control section 10B. Examples of the input/output section 19B include interfaces such as a universal serial bus (USB).

### (Control Section 10B and Storage Section 17B)

As in the case of the information processing apparatus 1A in accordance with the second example embodiment, the control section 10B includes a target data acquiring section 11, a reliability level calculating section 12, a pseudo label determining section 13, the plurality of pseudo label generating sections 14, a model acquiring section 15, the training section 16, an inference section 22, and a display control section 23 as illustrated in FIG. 10. Further, the control section 10B include a provision section 17 in addition to the above configuration.

Furthermore, as in the case of the information processing apparatus 1A in accordance with the second example embodiment, in the storage section 17B, a model group MGC, a pseudo label generation algorithm group AG, and a pseudo label group PLG are stored as illustrated in FIG. 10. A repetitive description of the configuration and data that have been described in the information processing apparatus 1A is omitted in the following description.

### (Model Acquiring Section 15)

The model acquiring section 15 in accordance with the present example embodiment acquires, via the communication section 18B, a plurality of models included in the model group provided by the server apparatus 3B. Note here that the model group includes, for example, at least one selected from the group consisting of the source model, the model obtained by aggregation, and a model acquired by the server apparatus 3B from another client apparatus.

### (Model Group MGC)

The model group MGC stored in the storage section 17B in accordance with the present example embodiment includes the models acquired by the model acquiring section 15. More specifically, the model group MGC stored in the storage section 17B includes the following:
a model provided by the server apparatus 3B as a training target in the client apparatus 1B (for example, the foregoing source model) or a model obtained by applying, to the model, the training process carried out by the training section 16 of the client apparatus 1B; and
a model acquired by the server apparatus 3B from a client apparatus different from the client apparatus 1B (in other words, a model trained in another client apparatus)

### (Provision Section 17)

The provision section 17 provides the server apparatus 3B with information pertaining to a trained model obtained by the training process carried out by the training section 16. For example, the provision section 17 provides the information pertaining to the trained model to the server apparatus 3B via the communication section 18B.

More specifically, the provision section 17 may be configured to provide the server apparatus 3B with a value of at least one parameter defining the trained model, or may be configured to provide the server apparatus 3B with an amount of change in such a parameter (for example, a difference from the previous step in a case where an iterative process is carried out).

The information processing system configured as described above brings about an effect similar to that brought about by the information processing apparatus 1A in accordance with the second example embodiment.

Further, according to the above configuration, by inputting, into at least one of a plurality of pseudo label generating means, the target data and at least one of a plurality of models included in a model group including a model trained in another client apparatus, a reliability level of the at least one of the plurality of models is calculated. Thus, a model trained in a client apparatus (another client apparatus) different from a certain client apparatus can be suitably used in calculation of a reliability level. Thus, as compared with a case where a pseudo label is generated with reference to only a model to be trained in a certain client apparatus, it is possible to further improve a reliability level of a pseudo label.

### (Description of Aspect as Federated Learning System)

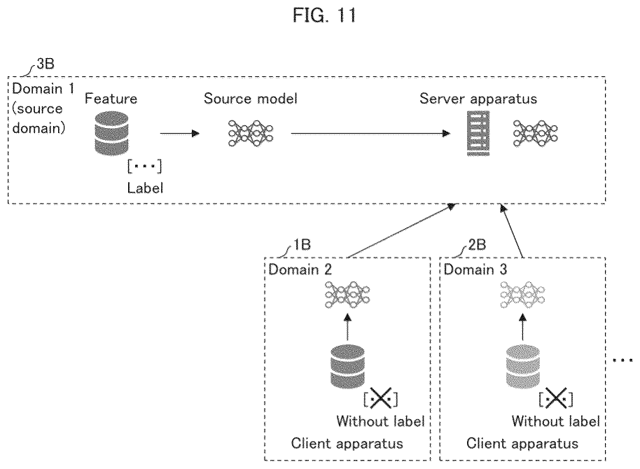

Next, an aspect of the information processing system 100B as a federated learning system will be described below with reference to FIG. 11. FIG. 11 is a view for describing the aspect of the information processing system 100B as the federated learning system. The information processing system 100B includes the server apparatus 3B and at least one client apparatus (information processing apparatus 1B) as described earlier. A plurality of client apparatuses are indicated as a client apparatus 1B and a client apparatus 2B, respectively, in the example illustrated in FIG. 11. Note here that the client apparatus 2B has a configuration similar to that of the client apparatus 1B.

In the example illustrated in FIG. 11, a domain 1, a domain 2, and a domain 3 are present as domains of data. Note here that the domain 1 is composed of, for example, data including target data (also denoted as “feature” in FIG. 11) and a ground-truth label (merely denoted as “label” in FIG. 11) associated with the target data. The domain 1 is sometimes called a source domain or source domain data. The domain 1 (source domain data) is referred to by the server apparatus 3B as illustrated in FIG. 11. More specifically, the source domain data is referred to as pre-training data by the generation section 34 and is used to generate a pre-trained model. The generated pre-trained model is provided as a source model to each of the client apparatuses 1B and 2B.

In contrast, as illustrated in FIG. 11, the domains 2 and 3 are each composed of data without a ground-truth label. In the example illustrated in FIG. 11, the client apparatus 1B refers to data (input data) without a ground-truth label to update, by the foregoing integration process and the foregoing training process, a model (local model) targeted by the client apparatus 1B, and provides the updated model to the server apparatus 3B. Same applies to the client apparatus 2B. Note that, although the domains 2 and 3 are sometimes referred to as target domains, such a wording is not intended to limit the present example embodiment.

Thus, the information processing system 100B in accordance with the present example embodiment has an aspect as a system for carrying out so-called federated learning, the aspect being such that
a model is provided by the server apparatus 3B to each of the client apparatuses 1B and 2B,
the model provided by the server apparatus 3B is updated in each of the client apparatuses 1B and 2B, and the updated model is provided to the server apparatus 3B, and
a model obtained by aggregation is generated by aggregating a plurality of models provided by the respective client apparatuses 1B and 2B, and the generated model obtained by aggregation is provided to each of the client apparatuses 1B and 2B.

Further, as described earlier, the information processing system 100B in accordance with the present example embodiment has an aspect as a system for carrying out domain adaptation, the aspect being such that
a source model generated with reference to a source domain is updated by applying the source model to a target domain, and
a model obtained by aggregation is generated by aggregating updated models in the server apparatus 3B, and the generated model obtained by aggregation is provided to each of the client apparatuses 1B and 2B.

As described above, the information processing system 100B in accordance with the present example embodiment is a system that is suitably applicable to a federated learning setting for domain adaptation. Further, for example, in a case where the information processing system 100B is applied to federated learning, a highly reliable pseudo label can be suitably generated in each client apparatus.

### Example Application

An example application of the information processing system 100B to a federated learning setting for domain adaptation can be, for example, the case of preparing a situation understanding model in which videos captured by surveillance cameras installed at a plurality of points are used.

In this case, for example, since data of an image captured at each point includes confidential information, the data cannot be disclosed (federated learning setting).

Further, videos captured by surveillance cameras installed at a plurality of points B, C, and D hold data whose domains are different, such as background information and camera performance (domain adaptation setting).

Furthermore, due to a plurality of points and a large data volume, it is difficult to carry out an operation to assign a label to data, and each client apparatus carries out unlabeled training (unlabeled training).

In such a situation, the information processing apparatus 1B in accordance with the present example embodiment carries out a process for
acquiring a source model from the server apparatus 3B,
using the acquired source model to update, as target data, a local model (called a local model 2) with reference to a video (the domain 2) captured by the surveillance camera installed at the point B, and
providing the updated model to the server apparatus 3B. Note here that such a process may be carried out repeatedly.

Similarly, an information processing apparatus 2B which has a configuration similar to that of the information processing apparatus 1B carries out a process for
acquiring a source model from the server apparatus 3B, using the acquired source model to update, as target data, a local model (called a local model 3) with reference to a video (the domain 3) captured by the surveillance camera installed at the point C, and
providing the updated model to the server apparatus 3B. Note here that such a process may be carried out repeatedly.

As described above, the information processing system 100B in accordance with the present example embodiment can suitably update a local model and a source model in a federated learning setting for domain adaptation. Further, in a process for generating a pseudo label for training the local model 2, a reliability level of the local model 2 and a reliability level of the local model 3 are calculated, and a pseudo label to be used for actual training is determined in accordance with the calculated reliability levels. Similarly, in a process for generating a pseudo label for training the local model 3, the reliability level of the local model 3 and the reliability level of the local model 2 are calculated, and a pseudo label to be used for actual training is determined in accordance with the calculated reliability levels. Thus, in a federated learning setting for domain adaptation, the information processing system 100B in accordance with the present example embodiment can carry out a training process in which a highly reliable pseudo label is used in each of the client apparatuses (the information processing apparatus 1B, the information processing apparatus 2B, . . . ). Further, a local model thus trained can be used to suitably carry out an inference process in each client apparatus.

### (Flow of Process Carried Out by Information Processing System 100B)

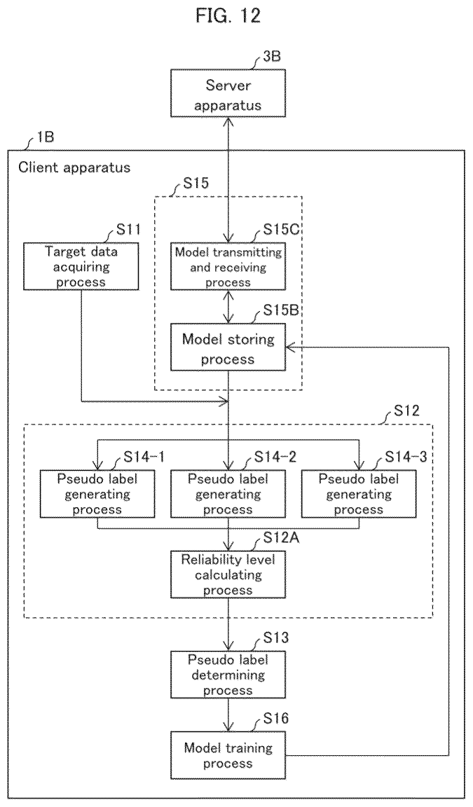

Next, a flow of a process carried out by the information processing system 100B in accordance with the present example embodiment will be described with reference to FIG. 12. As illustrated in FIG. 12, the client apparatus (information processing apparatus) 1B included in the information processing system 100B carries out processes similar to those carried out by the information processing apparatus 1A in accordance with the second example embodiment. Note, however, that the information processing apparatus 1B in accordance with the present example embodiment differs from the information processing apparatus 1A in that an acquisition process S15 includes a model transmitting and receiving process S15C. Note here that the model transmitting and receiving process S15C includes a process for acquiring the model group provided by the server apparatus 3B, and providing the server apparatus 3B with a model to which the training process carried out by the model training section 16 is applied.

Further, in a pseudo label determining process S13 illustrated in FIG. 12, any of the pseudo label selecting process S13A and the pseudo label regenerating process S13B that have been described in the information processing apparatus 1A in accordance with the second example embodiment may be carried out. A description of the other processes is omitted here because the description overlaps the description of the processes carried out by the information processing apparatus 1A in accordance with the second example embodiment.

### (Additional Remarks on Client Apparatus (Information Processing Apparatus) 1B)

The above description has discussed a local model updating process (training process) carried out in the client apparatus (information processing apparatus) 1B. Note, however, that the present example embodiment also includes, as a client apparatus (information processing apparatus), an apparatus specialized in an inference phase. In a case where the foregoing configuration of the client apparatus 1B is taken as an example, the client apparatus 1B may be configured to include, as the control section 10B, only a target data acquiring section 11 that acquires input data (inference data) and an inference section 22 that uses a trained model to carry out an inference process with respect to the input data. Note here that the trained model may be configured to be any model generated by the foregoing training process, or may be configured to be a model obtained by aggregation and provided by the server apparatus 3B.

As described above, according to the present example embodiment, a highly accurate local model and a highly accurate model obtained by aggregation can be generated by the foregoing training process. This makes it possible to carry out an inference process in which such a highly accurate model is used.

### Example Application

The following description will additionally discuss a specific example application of the information processing system 100B in accordance with the present example embodiment. The information processing system 100B is applicable to various types of industries, and several examples are described below. Note, however, that these examples are not intended to limit the present example embodiment, and are, of course, applicable to other types of industries. Further, the information processing system 100B can also be applied across several types of industries.

### First Example: Related to Finance

The information processing system 100B in accordance with the present example embodiment may be applied to, for example, a finance-related field.

For example, a configuration may be such that a plurality of client apparatuses 1B, 2B, . . . are each disposed in each of a plurality of bank branches, and a model which predicts a default risk from features (a debt and a business situation) of a debtor of a corresponding branch is trained by the training section 16 in each of the client apparatuses 1B. In the case of such a configuration, data of each branch or each group corresponds to the foregoing source domain data. For example, the server apparatus 3B generates a source model with reference to the source domain data and distributes the source model to each of the client apparatuses 1B, 2B, . . . .

As another example, a configuration may be such that a plurality of client apparatuses 1B, 2B, . . . are each disposed in each of a plurality of insurance company branches, and a model which predicts a premium for a client of a corresponding branch from data such as a medical history, age, blood pressure, and a gene of the client is trained by the training section 16 in each of the client apparatuses 1B. In the case of such a configuration, data of each branch or each insurance company corresponds to the foregoing source domain data. For example, the server apparatus 3B generates a source model with reference to the source domain data and distributes the source model to each of the client apparatuses 1B, 2B, . . . .

Note that prediction results from the models for the default risk and the premium are examples of information in accordance with the present example embodiment which information supports decision making by a user.

### (Second Example: Related to Medical Treatment and Healthcare)

The information processing system 100B in accordance with the present example embodiment may be applied to, for example, a medical-related field.

For example, a configuration may be such that a plurality of client apparatuses 1B, 2B, . . . are each disposed in each of a plurality of clinics, and a model which uses a symptom described in a chart or the like of a patient of a corresponding clinic to estimate a cause of a disease and present a treatment method is trained by the training section 16 in each of the client apparatuses 1B. In the case of such a configuration, data of each clinic corresponds to the foregoing source domain data. For example, the server apparatus 3B generates a source model with reference to the source domain data and distributes the source model to each of the client apparatuses 1B, 2B, . . . .

As another example, a configuration may be such that a plurality of client apparatuses 1B, 2B, . . . are each disposed in each of a plurality of pharmaceutical companies, and a model which predicts activity of a compound from a structure of the compound (ligand), a structure of protein, and the like is trained by the training section 16 in each of the client apparatuses 1B. In the case of such a configuration, data (for example, data pertaining to activity against a compound library) of each pharmaceutical company corresponds to the foregoing source domain data. For example, the server apparatus 3B generates a source model with reference to the source domain data and distributes the source model to each of the client apparatuses 1B, 2B, . . . .

Note that prediction results from the models for the treatment method and the activity of the compound are examples of information in accordance with the present example embodiment which information supports decision making by a user.

### Third Example: Related to Machine

The information processing system 100B in accordance with the present example embodiment may be applied to, for example, a machine-related field.

For example, a configuration may be such that a plurality of client apparatuses 1B, 2B, . . . are each disposed in each of a plurality of factories, and a model which controls the operation of a robot in a corresponding factory with reference to situations (a manufacturing situation and a transport situation) of the corresponding factory is trained by the training section 16 in each of the client apparatuses 1B. In the case of such a configuration, data of each factory and each warehouse correspond to the foregoing source domain data. For example, the server apparatus 3B generates a source model with reference to the source domain data and distributes the source model to each of the client apparatuses 1B, 2B, . . .

As another example, a configuration may be such that a plurality of client apparatuses 1B, 2B, . . . are each disposed in each of a plurality of transportation apparatuses (automobiles, airplanes, ships, etc.), and a model which controls a corresponding transportation apparatus or controls a signal from data such as a scene from the corresponding transportation apparatus, a measurement situation of the corresponding transportation apparatus, or a congestion level is trained by the training section 16 in each of the client apparatuses 1B. In the case of such a configuration, data from the respective transportation apparatuses and data of, for example, a signal correspond to the foregoing source domain data. For example, the server apparatus 3B generates a source model with reference to the source domain data and distributes the source model to each of the client apparatuses 1B, 2B, . . . .

As another example, a configuration may be such that a plurality of client apparatuses 1B, 2B, . . . are each disposed in each of a plurality of logistics companies, and a model which derives a (change in) transportation route from a situation of a transport object or a situation of a transportation apparatus in a corresponding logistics company is trained by the training section 16 in each of the client apparatuses 1B. In the case of such a configuration, data pertaining to a situation of a transportation apparatus or a situation of a transport object in each logistics company (each site) corresponds to the foregoing source domain data. For example, the server apparatus 3B generates a source model with reference to the source domain data and distributes the source model to each of the client apparatuses 1B, 2B, . . . .

### Fourth Example: Related to Trial

The information processing system 100B in accordance with the present example embodiment may be applied to, for example, a trial-related field.

For example, a configuration may be such that a plurality of client apparatuses 1B, 2B, . . . are each disposed in each of a plurality of courts, and a model which derives, for example, sentencing from data handled in a corresponding court, such as a situation of, for example, a crime, a situation of a piece of evidence, a law, and a trial precedent is trained by the training section 16 in each of the client apparatuses 1B. In the case of such a configuration, data on which each trial in each court is based, or data such as a recidivism rate corresponds to the foregoing source domain data. For example, the server apparatus 3B generates a source model with reference to the source domain data and distributes the source model to each of the client apparatuses 1B, 2B, . . . .

Note that prediction results from the models for, for example, sentencing are examples of information in accordance with the present example embodiment which information supports decision making by a user.

### Additional Remarks on Example Embodiments

Note that the configurations described in the example embodiments are not limited to the foregoing examples. The example embodiments each may have the following configuration so as to overcome some secondary problems that can arise in practical operation of federated learning.

For example, the example embodiments each preferably have a configuration such that confidentiality of a model parameter is ensured during transmission of the model parameter from each client apparatus to a server apparatus. For example, in order that confidentiality of a model parameter per se can be ensured, the information processing system described in each of the example embodiments may have a configuration related to homomorphic encryption or the like that allows calculation with the model parameter kept confidential.

For example, a configuration may be such that the provision section 17 of each of the client apparatuses 1B includes an encryption section which encrypts model parameters by homomorphic encryption or the like, and the aggregation section 32 of the server apparatus 3B aggregates the encrypted model parameters with the model parameter kept confidential. Further, a configuration may be such that the provision section 33 of the server apparatus 3B includes an encryption section which encrypts a model parameter of a source model by homomorphic encryption or the like, and the model acquiring section 15 of each of the client apparatuses 1B decodes the model parameter.

Furthermore, the example embodiments each preferably have a configuration that makes it possible to reduce a data size of a model parameter as much as possible during transmission of the model parameter from each client apparatus to a server apparatus. For example, each of the client apparatuses 1B and the server apparatus 3B may be configured to subject a model parameter to data compression. Moreover, at least any of each of the client apparatuses 1B and the server apparatus 3B may include a model reconstructing section that reduces a size of a model by reconstructing the model (generating a distillation model, a derived model, a pseudo model, or a higher-level model). Such a configuration is suitable, for example, in a situation where processing performance of a client apparatus is limited.

Further, for example, the client apparatuses 1B each of which is realized as a wearable device each may be configured to control transmission of a model parameter to the server apparatus 3B in accordance with a remaining battery level. For example, in the case where the remaining battery level is not more than a predetermined remaining level, the client apparatuses 1B each may be configured to transmit, to the server apparatus 3B, only a model parameter which is among a plurality of model parameters and in which a change from a previous value is not less than a predetermined value (ratio). Alternatively, the client apparatuses 1B each may be configured to apply a sampling process (for example, extraction of only 10% by random sampling) to acquired data and use only sampled data to carry out the training process by the training section 16. Alternatively, the client apparatuses 1B each may be configured to store acquired data in another apparatus (for example, the server apparatus 3B).

### Software Implementation Example

Some or all of the functions of the information processing apparatuses 1, 1-1, 1-2, 1A, 1B, 2B, 1B-1, 1B-2, . . . , and the server apparatuses 3 and 3B (hereinafter also referred to as “each apparatus”) may be implemented by hardware such as an integrated circuit (IC chip), or may be implemented by software.

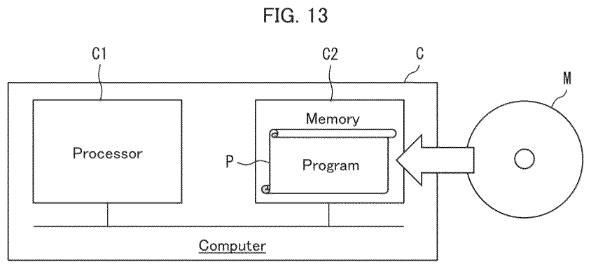

In the latter case, the each apparatus is realized by, for example, a computer that executes instructions of a program that is software implementing the functions. FIG. 13 illustrates an example of such a computer (hereinafter referred to as “computer C”). FIG. 13 is a block diagram illustrating a hardware configuration of the computer C which functions as the each apparatus.

The computer C includes at least one processor Cl and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded in a case where the program P is executed and in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be recorded in a non-transitory tangible recording medium M which is readable by the computer C. Examples of the recording medium M include a tape, a disk, a card, a semiconductor memory, and a programmable logic circuit. The computer C can acquire the program P via the recording medium M. The program P can be transmitted via a transmission medium. Examples of the transmission medium include a communications network and a broadcast wave. The computer C can acquire the program P also via the transmission medium.

### [Additional Remarks]

The present disclosure includes techniques described in supplementary notes below. Note, however, that the present invention is not limited to the techniques described in the supplementary notes below, but may be altered in various ways by a skilled person within the scope of the claims.

### (Supplementary Note A1)

An information processing apparatus including:
a target data acquiring means for acquiring target data;
a reliability level calculating means for, from at least one of a plurality of models and the target data, calculating a reliability level of the at least one of the plurality of models on the basis of an agreement degree between labels obtained by at least one of a plurality of label generating means; and
a label determining means for referring to the reliability level to determine a label to be assigned to the target data.

### (Supplementary Note A2)

The information processing apparatus described in supplementary note A1, wherein
the label determining means selects, as the label to be assigned to the target data, a label generated by inputting, into the at least one of the plurality of label generating means, the target data and a model that has a higher reliability level among reliability levels calculated by the reliability level calculating means for the respective plurality of models.

### (Supplementary Note A3)

The information processing apparatus described in supplementary note A1, wherein
by inputting, into the at least one of the plurality of label generating means, the target data and each of models each of which has a higher reliability level among reliability levels calculated by the reliability level calculating means for the respective plurality of models, the label determining means generates the label to be assigned to the target data.

### (Supplementary Note A4)

The information processing apparatus described in supplementary note A2 or A3, wherein
the reliability level calculating means assigns, to a first model among the plurality of models, a reliability level in accordance with an agreement degree between
   a first label obtained by inputting the first model and the target data into a first label generating means among the plurality of label generating means and
   a second label obtained by inputting the first model and the target data into a second label generating means among the plurality of label generating means.

### (Supplementary Note A5)

The information processing apparatus described in any one of supplementary notes A2 to A4, wherein
the reliability level calculating means refers to:
a first agreement degree, which is a degree of agreement between
   a first label obtained by inputting a first model among the plurality of models and the target data into a first label generating means among the plurality of label generating means and
   a second label obtained by inputting the first model and the target data into a second label generating means among the plurality of label generating means; and
a second agreement degree, which is a degree of agreement between
   a third label obtained by inputting a second model among the plurality of models and the target data into the first label generating means and
   a fourth label obtained by inputting the second model and the target data into the second label generating means, and
assigns a higher reliability level to the first model than to the second model in a case where the first agreement degree is higher than the second agreement degree.

### (Supplementary Note A6)

The information processing apparatus described in any one of supplementary notes A1 to A5, further including a training means for referring to the label determined by the label determining means, and carrying out a machine learning process related to the at least one of the plurality of models.

### (Supplementary Note A7)

The information processing apparatus described in supplementary note A6, further including
an inference means for carrying out an inference process in which the at least one of the plurality of models that has been trained by the machine training process is used.

### (Supplementary Note A8)

The information processing apparatus described in any one of supplementary notes A1 to A7, further including
a display means for displaying at least one selected from the group consisting of
(i) the reliability level calculated by the reliability level calculating means and
(ii) information that has been obtained with use of a model which has been trained by machine learning with reference to the label and that supports decision making by a user.

### (Supplementary Note A9)

The information processing apparatus described in any one of supplementary notes A1 to A8, further including
a model transmitting and receiving means for carrying out at least one selected from the group consisting of (i) a process for acquiring the at least one of the plurality of models from another apparatus and (ii) a process for providing the at least one of the plurality of models to another apparatus.

### (Supplementary Note A10)

An information processing system including a server apparatus and a plurality of client apparatuses,
the server apparatus including
   an acquisition means for acquiring models from the respective plurality of client apparatuses,
   an aggregation means for aggregating the models acquired from the respective plurality of client apparatuses, and
   a provision means for providing each of the plurality of client apparatuses with a model group including the models aggregated by the aggregation means,
the plurality of client apparatuses each including
   a model acquiring means for acquiring a plurality of models included in the model group provided by the server apparatus,
   a target data acquiring means for acquiring target data,
   a reliability level calculating means for, from at least one of the plurality of models and the target data, calculating a reliability level of the at least one of the plurality of models on the basis of an agreement degree between labels obtained by at least one of a plurality of label generating means,
   a label determining means for referring to the reliability level to determine a label to be assigned to the target data, and
   a training means for carrying out a training process with reference to the label determined by the label determining means.

### (Supplementary Note A11)

An information processing method including:
acquiring target data;
from at least one of a plurality of models and the target data, calculating a reliability level of the at least one of the plurality of models on the basis of an agreement degree between labels obtained by at least one of a plurality of label generating means; and
referring to the reliability level to determine a label to be assigned to the target data.

### (Supplementary Note A12)

A program for causing a computer to function as an information processing apparatus,
the program causing the computer to carry out:
a target data acquiring means for acquiring target data;
a reliability level calculating means for, from at least one of a plurality of models and the target data, calculating a reliability level of the at least one of the plurality of models on the basis of an agreement degree between labels obtained by at least one of a plurality of label generating means; and
a label determining means for referring to the reliability level to determine a label to be assigned to the target data.

### REFERENCE SIGNS LIST

1, 1A . . . Information processing apparatus
1-1, 1-2, 1B, 2B . . . Information processing apparatus (client apparatus)
11 . . . Target data acquiring section
12 . . . Reliability level calculating section
13 . . . Pseudo label determining section (label determining section)
14 . . . Pseudo label generating section (label generating section)
15 . . . Model acquiring section
16 . . . Training section
17 . . . Provision section
22 . . . Inference section
3, 3B . . . Server apparatus
31 . . . Acquisition section
32 . . . Aggregation section
33 . . . Provision section
100B . . . Information processing system

1. An information processing apparatus comprising at least one processor, the at least one processor carrying out:
a target data acquiring process for acquiring target data;
a reliability level calculating process for, from at least one of a plurality of models and the target data, calculating a reliability level of the at least one of the plurality of models on the basis of an agreement degree between labels obtained by at least one of a plurality of label generating means; and
a label determining process for referring to the reliability level to determine a label to be assigned to the target data.

2. The information processing apparatus according to claim 1, wherein
in the label determining process, the at least one processor selects, as the label to be assigned to the target data, a label generated by inputting, into the at least one of the plurality of label generating means, the target data and a model that has a higher reliability level among reliability levels calculated by the reliability level calculating process for the respective plurality of models.

3. The information processing apparatus according to claim 1, wherein
in the label determining process, by inputting, into the at least one of the plurality of label generating means, the target data and each of models each of which has a higher reliability level among reliability levels calculated by the reliability level calculating process for the respective plurality of models, the at least one processor generates the label to be assigned to the target data.

4. The information processing apparatus according to claim 2, wherein
in the reliability level calculating process, the at least one processor assigns, to a first model among the plurality of models, a reliability level in accordance with an agreement degree between
a first label obtained by inputting the first model and the target data into a first label generating means among the plurality of label generating means and
a second label obtained by inputting the first model and the target data into a second label generating means among the plurality of label generating means.

5. The information processing apparatus according to claim 2, wherein
in the reliability level calculating process, the at least one processor refers to:
a first agreement degree, which is a degree of agreement between
a first label obtained by inputting a first model among the plurality of models and the target data into a first label generating means among the plurality of label generating means and
a second label obtained by inputting the first model and the target data into a second label generating means among the plurality of label generating means; and
a second agreement degree, which is a degree of agreement between
a third label obtained by inputting a second model among the plurality of models and the target data into the first label generating means and
a fourth label obtained by inputting the second model and the target data into the second label generating means, and
assigns a higher reliability level to the first model than to the second model in a case where the first agreement degree is higher than the second agreement degree.

6. The information processing apparatus according to claim 1, wherein
the at least one processor refers to the label determined by the label determining process, and further carries out a machine learning process related to the at least one of the plurality of models.

7. The information processing apparatus according to claim 6, wherein
the at least one processor further carries out an inference process in which the at least one of the plurality of models that has been trained by the machine training process is used.

8. An information processing system comprising a server apparatus and a plurality of client apparatuses,
the server apparatus including at least one first processor, the at least one first processor carrying out
an acquisition process for acquiring models from the respective plurality of client apparatuses,
an aggregation process for aggregating the models acquired from the respective plurality of client apparatuses, and
a provision process for providing each of the plurality of client apparatuses with a model group including the models aggregated by the aggregation process,
the plurality of client apparatuses each including at least one second processor, the at least one second processor carrying out
a model acquiring process for acquiring a plurality of models included in the model group provided by the server apparatus,
a target data acquiring process for acquiring target data,
a reliability level calculating process for, from at least one of the plurality of models and the target data, calculating a reliability level of the at least one of the plurality of models on the basis of an agreement degree between labels obtained by at least one of a plurality of label generating means,
a label determining process for referring to the reliability level to determine a label to be assigned to the target data, and
a training process with reference to the label determined by the label determining process.

9. An information processing method comprising:
acquiring target data;
from at least one of a plurality of models and the target data, calculating a reliability level of the at least one of the plurality of models on the basis of an agreement degree between labels obtained by at least one of a plurality of label generating processes; and
referring to the reliability level to determine a label to be assigned to the target data.

10. A non-transitory recording medium storing therein a program for causing a computer to function as the information processing apparatus according to claim 1, the program causing the computer to carry out:
the target data acquiring process;
the reliability level calculating process; and
the label determining process.
